(19) United States
(12) Patent Application Publication
(10) Pub. No.: US 2007/0045328 A1
(43) Pub. Date: Mar. 1, 2007

(54) PROTECTO PLATE

(76) Inventor: Jeffrey C. Smith, Port St. Lucie, FL (US)

Correspondence Address: MALIN HALEY AND DIMAGGIO, PA, 1936 S ANDREWS AVENUE, FORT LAUDERDALE, FL, 33316, US

(21) Appl. No.: 11/467,757

(22) Filed: Aug. 28, 2006

Related U.S. Application Data
(60) Provisional application No. 60/596,083, filed on Aug. 30, 2005.

(51) Int. Cl. B62D 33/00

(52) U.S. Cl. 220/562

(57) ABSTRACT

The present invention relates to a barrier protection device and method for use on a fuel tank. The present invention includes a flexible but yet resilient sheet of material which attaches to a fuel tank. The sheet of material principally protects the underside of the fuel tank and straps are used to firmly attach the sheet to the fuel tank. Stabilizing pads are placed between the sheet and the fuel tank in order to stabilize the sheet once the sheet is attached to the fuel tank. The present invention may be preferably used on tractor trailer fuel tanks which are exposed to debris when the tractor trailer is moving.

### BACKGROUND OF THE INVENTION

1. Field of the Invention

The present invention relates to a barrier protection system for use on semi-tractor fuel tank.

2. Description of Related Art

Most semi-tractors use fuel tanks that are exposed on their underside. The exposed underside may be subjected to various flying objects and other road debris during operation. Accordingly, the exposed side of the fuel tank may develop a leak if struck by an object with enough size and force. A flying object may easily strike the tank, puncture the tank and cause a leak and/or possible fire. Some devices in the prior art have been developed to address this problem, however the prior art has various shortcomings as discussed below.

U.S. Pat. No. 6,099,042 to Cook et al. (Cook) relates to a fuel tank support for supporting and protecting a plastic fuel tank. The Cook fuel support includes front, rear, side and bottom walls that form an enclosure having an exterior and interior for holding the fuel tank. The fuel tank support also includes a pair of mounting support structures integrally formed into the front wall, rear wall and bottom wall. A pair of mounting flanges is formed on a peripheral edge of the front and rear walls, respectively, and integrally formed to the mounting support structures for mounting the fuel tank support to the vehicle. The Cook fuel tank support substantially covers five sides of a fuel tank and includes the use of flanges for attachment to the vehicle. The fuel tank support of Cook is apparently designed for use with an automotive fuel tank and lacks any flexibility to apply to any other tank design other than that disclosed in Cook.

U.S. Pat. No. 5,992,885 to Fukagawa et at. relates to a fuel cylinder mounting structure of a motorcar running by natural gas. The Fukagawa mounting structure includes a chassis frame having a rectangular frame-like shape, supporting the fuel cylinder and attached to a car-body frame from the bottom; a protection plate fixed to the chassis frame for covering the fuel cylinder from the bottom; suspensions attached to both sides of the chassis frame; and a spare tire rack attached under a rear car-body and supporting a spare tire. The Fukagawa mounting structure includes a protection plate that protects the fuel cylinder from flying stones. The protection plate is a rectangular plate that includes attachment sections that are attached to frame members by bolts. The protection plate of Fukagawa in permanently affixed to the mounting structure specifically designed for incorporation with the mounting structure. The protection plate of Fukagawa lacks any flexibility to be used on any other tank system and may be limited to use in the mounting structure of Fukagawa.

U.S. Pat. No. 4,930,811 to Tsukada et al. relates to a device for protecting a plastic fuel tank for an engine of a motor vehicle from flame comprising a flame cutoff plate disposed between an exhaust gas passage member of the engine and a wall of the fuel tank. The cutoff plate of Tsukada protects a portion of a fuel tank that may come in contact with a gas passage member. The cutoff plate of Tsukada as with the other prior art bolts permanently into place and leaves a significant portion of the underside to the fuel tank exposed.

The prior art fails to disclose fuel tank protection that may be easily used on multiple vehicles. The fuel tank protection of the prior art is typically permanently affixed the vehicle frame or extension thereof and consequently limited to use on the specifically designed fuel tanks, i.e., auto fuel tanks, thus lacking flexible use on multiple vehicles especially on larger trucking fuel tanks. The prior art fails to disclose fuel tank protection that may easily attached and removed for use on multiple vehicles, especially trucks.

### SUMMARY OF THE INVENTION

The present invention relates to a protective barrier system that may be universally used to protect fuel tanks on semi-trucks from flying debris. The protective barrier covers the horizontal plane on the underside of the fuel tank. The protective barrier covers the horizontal plane on the underside of the fuel tank. The protective barrier attaches to a fuel tank through the utilization of two evenly spaced straps. The protective system also includes the use of rubber blocks to stabilize the barrier and limit any horizontal movement. The protective barrier may be use on a fuel tank that is exposed on its underside. The protective barrier may be used on a fuel tank that is exposed on its underside. The protective barrier is especially useful on semi-truck fuel tanks.

In accordance with these and other objects which will become apparent hereinafter, the instant invention will now be described with particular reference to the accompanying drawings.

### BRIEF DESCRIPTION OF THE DRAWINGS

FIG. 1 shows a layout of the components of the present invention.

FIG. 2 shows an exemplary application of the present invention.

FIG. 3 shows a cross sectional view of the present invention used on a tank as shown in FIG. 2.

FIG. 4 shows an under carriage view of the present invention used on a dual tank system with additional crossover protection.

### DETAILED DESCRIPTION

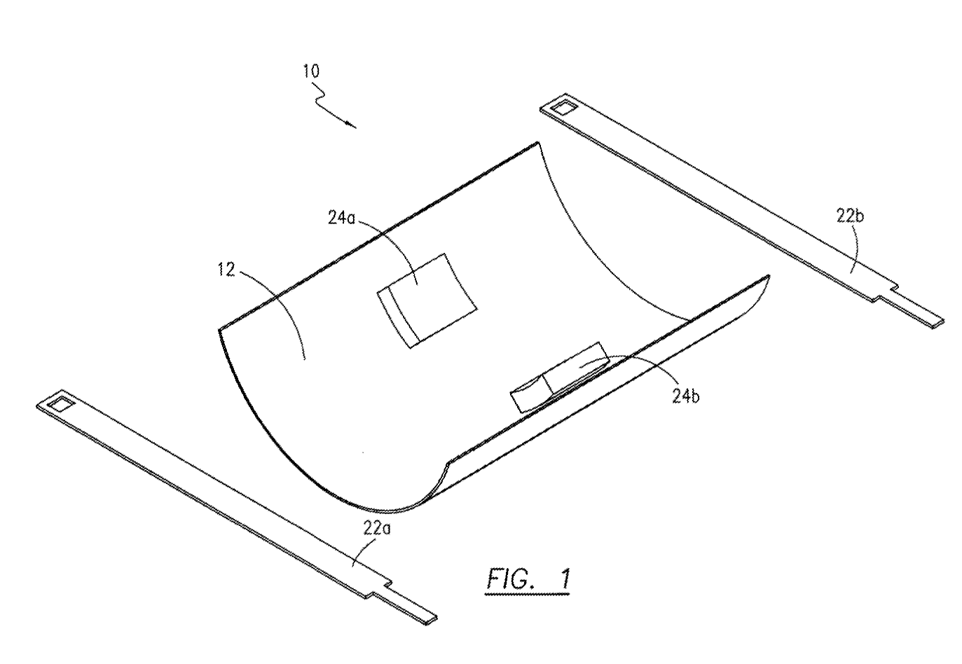

FIG. 1 shows an overview/layout of components of the protection plate system according to the present invention. The protection plate system includes a primary protective barrier 10 that is used with attachments straps 22a, 22b. Also shown in FIG. 1 are two pads 24a and 24b that lie on surface 12. The barrier 10 is shown with a semi-parabolic shape in order to conform to the underside of the fuel tanks typically used on semi-tractor trucks. The primary protective barrier 10 serves as a protective barrier to prevent foreign objects from being thrown into contact with a tank or fuel container. The protective barrier 10 therefore prevents the tank or container form being struck and creating a substantial spill. In one exemplary embodiment, the protective barrier 10 is used in the conjunction with attachment straps 22a, 22b and the support pads 24a, 24b.

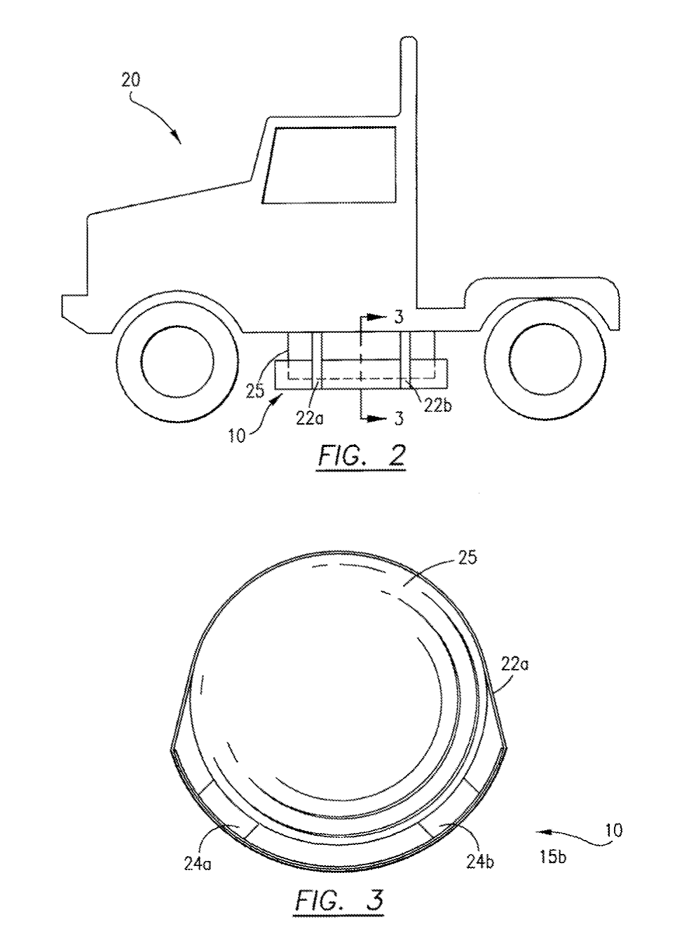

Referring now to FIG. 2, an exemplary application of the present invention is shown. A transport vehicle 20 is shown where protective barrier 10 is attached to fuel tank 25. Most transport vehicles such as shown in FIG. 2 include at least one cylindrical fuel tank as shown in FIG. 2. Although no set parameters are suggested for application of the protective barrier 10, the lateral length of barrier 10 is advantageously greater than the cylindrical diameter of the fuel tank 25. Also, the longitudinal length of barrier 10 is greater than the longitudinal length of the cylindrical fuel tank 25. Such parameters ensure that the protective barrier 10 has a horizontal planar surface sufficient to cover the fuel tank 25, and consequently ensures that the protective barrier 10 provides adequate protection of the fuel tank 25 from being struck with any foreign object that may inadvertently be thrown in the direction of the fuel tank 25. The protective barrier 10 may be easily mounted and removed onto and from the fuel tank 25 by using attachment straps 22a and 22b as shown in FIG. 2. Attachment straps 22a and 22b go around the underside of the primary protective barrier 10 and circle around the lower circumference of the fuel tank 25. As shown in FIG. 2, the attachment straps 22a, 22b are placed at the substantial left and substantial right ends of the fuel tank 25. The spacing between straps 22a, 22b, although not set specifically, helps to ensure that the weight of the protective barrier 10 is substantially evenly distributed between the attachment straps 22a, 22b.

Referring now to FIG. 3, a cross-sectional view of the present invention as used on a fuel tank 25 is shown. As can be seen in this cross-sectional view, the protective barrier 10 protects the underside of the fuel tank 25 where the attachment straps 22a, 22b (not shown) hold the barrier 10 in place. Two support pads 24a and 24b are placed on surface 12 of the protective barrier 10. The support pads 24a, 24b increase the stability of the barrier 10 by decreasing the likelihood of any circumferential movement of the barrier 12 around the circumference of the cylindrical tank 25. The support pads 24a, 24b also reduce the horizontal side-to-side movement of the barrier 10 and as a consequence substantially reduce abrasive wear on the tank 10 and the bottom surface 12 at their contact point.

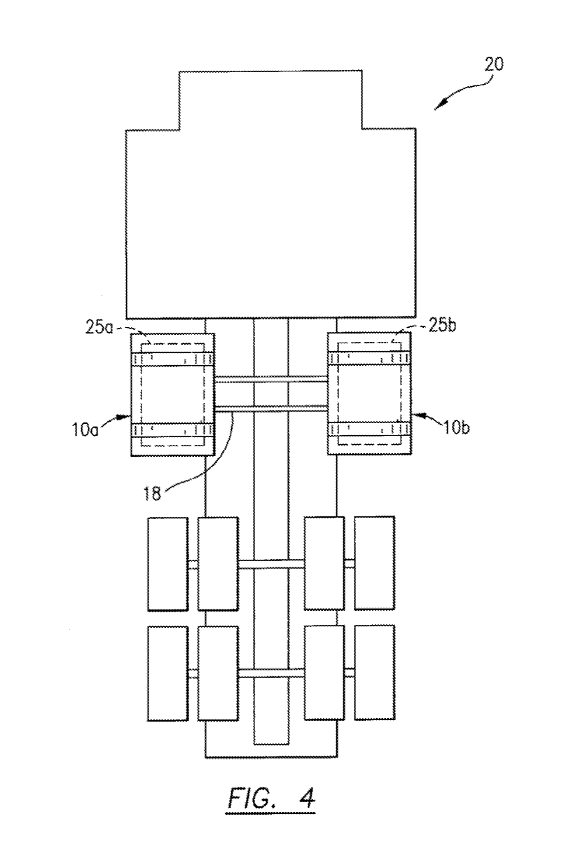

Referring now to FIG. 4, an alternative embodiment of the present invention is shown. FIG. 4 shows an undercarriage view of the present invention as used on a dual tank system with additional crossover protection. In FIG. 4, the transport vehicle 20 is shown to have a dual fuel tank system with fuel tanks 25a, 25b shown on each outside edge of the transport vehicle. Protective barriers 10a, 10b protect the undersides of the fuel tanks 25a, 25b. The protective barriers 10a and 10b are attached to each respective fuel tank through the use of attachment straps as shown in FIG. 2. This embodiment as shown in FIG. 4 includes a crossover protective barrier 18. The cross-protective barrier 18 connects to each barrier plate 10a, 10b and extends across the open area on the undercarriage between the two protective barriers. The cross-protective barrier 18 connects to the respective protective barriers 10a, 10b via a connection means not shown. The connection means may include the use bolts, clamps, clips or other suitable means that ensures the integrity of the protective barriers 10a, 10b, but however ensures the connection and stability of the cross-barrier 18. The crossover protective barrier 18 provides further support of the protective barriers, but also provides a means for protection of pickup or crossover lines that may be unprotected lying on the undercarriage of the transport vehicle 20.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A protective barrier for a section of a container comprising:
a. a flexible and resilient sheet of material;
b. an attachment means for attaching the material to the container; and
c. a stabilizing means positioned between the material and container for stabilizing the attachment of the material to the container.

2. The protective barrier according to claim 1, where said container is an external gas tank on a truck.

3. The protective barrier according to claim 2, where the sheet of material covers the underside of said tank.

4. The protective barrier according to claim 1, where the attachment means includes at least two straps.

5. The protective barrier according to claim 4, where said at least two straps surrounds both the sheet and tank.

6. The protective barrier according to claim 4, where said stabilizing means includes at least one stabilizing pad.

7. The protective barrier according to claim 3, where said sheet of material covers the entire underside of said tank and extends beyond the outer-edge of the tank.

8. The protective barrier according to claim 6, where at least one stabilizing pad is evenly positioned between the sheet and tank.

9. A device for covering a section of a container comprising:
a. a flexible and resilient barrier;
b. at least one attachment strap, where said attachment strap secures the barrier to the container; and
c. at least one stabilizing pad, where said stabilizing pad rests between said barrier and container.

10. The device according to claim 9, where said container is an external gas tank on a truck.

11. The device according to claim 10, where the barrier covers the underside of the said tank.

12. The device according to claim 10, where said at least two straps surrounds both the sheet and tank.

13. The device according to claim 10, where said barrier covers the entire underside of said tank and barrier extends beyond the outer-edge of the tank.

14. The device according to claim 10, where the at least one stabilizing pad is evenly positioned between the sheet and tank.

15. A method of protecting a section of a container comprising the steps of:
a. attaching a flexible and resilient barrier to the container;
b. using at least one strap to attach the barrier to the container; and
c. inserting at least one stabilizing pad between the barrier and container.

16. The method according to claim 15, where said container includes a gas tank on a truck.

17. The method according to claim 16, further including the step of:
a. covering the entire underside of the gas tank.

18. The method according to claim 16, further including the step of:
a. extending the barrier beyond the outer edge of the tank.

19. The method according to claim 16, further including the step of:
a. evenly positioning the at least one stabilizing pad between the barrier and container.
